(19) United States
(12) Patent Application Publication
(10) Pub. No.: US 2010/0098813 A1
(43) Pub. Date: Apr. 22, 2010

(54) FOOD PRODUCT MADE FROM DEHYDRATED PRICKLY PEAR CACTUS

(76) Inventor: CAROLE BUSH, Malibu, CA (US)

Correspondence Address: STETINA BRUNDA GARRED & BRUCKER, 75 ENTERPRISE, SUITE 250, ALISO VIEJO, CA, 92656, US

(21) Appl. No.: 12/641,754

(22) Filed: Dec. 18, 2009

Related U.S. Application Data
(63) Continuation of application No. 11/574,038.

(30) Foreign Application Priority Data
Sep. 7, 2004 (MX) PA/A/2004/008654

(51) Int. Cl. A23L 1/212; A23B 7/02; A23L 1/22

(52) U.S. Cl. 426/106; 426/640

(57) ABSTRACT

A nutritious food product, made with cooked, seasoned and dehydrated prickly pear pads, and a method for its production. The resulting product has the appearance of an appetizer made of cured meat, but with improved taste and appearance, free of hormones or animal fat. The product of the present invention has a long shelf life and does not require either preservatives or refrigeration, making it an ideal appetizer or snack. The resulting product provides the consumer with the benefits of the prickly pear and also is economically affordable.

### CROSS-REFERENCE TO RELATED APPLICATIONS

The present application is a continuation of U.S. patent application Ser. No. 11/574,038, filed Sep. 7, 2005, entitled FOOD PRODUCT MADE FROM DEHYDRATED PRICKLY PEAR CACTUS, which claims priority to PA/A/2004/008654, filed in Mexico on Sep. 7, 2004, all of the teachings of which are incorporated herein by reference.

### STATEMENT RE: FEDERALLY SPONSORED RESEARCH/DEVELOPMENT

Not Applicable

### BACKGROUND

1. Field of the Invention

The present invention relates to food products made from dehydrated vegetables, and more particularly, to a food product made from dehydrated prickly pear cactus pads that mimics beef jerky, with improved flavor and appearance.

2. Background of the Invention

In recent years the elements that constitute a healthy food have been redefined. Foods with low calories and low fat have become more popular, including products such as appetizers, sweets and snacks.

Dehydrated vegetables and fruits constitute ideal appetizers and sweets, because they are nutritious, have few calories, do not need preservatives, and have a long shelf life. There are several methods to dehydrate these foods, ranging from simple procedures such as drying in an oven or leaving it dry by the sun, to more sophisticated ones, such as hot air dehydration or freeze-drying.

Appetizers made from cured or processed meat, or that imitates meat, are other examples of the application of the principle of dehydration to obtain food products with high nutritional contents. U.S. Pat. Nos. 4,239,785 and 4,126,705 are examples this. The latter patent describes a foodstuff made with fish, beef, chicken, or even vegetable protein. In some circumstances protein obtained from soy can be used but, although the product has an appearance similar to products made with real meat, the flavor is vastly inferior. Other products of this type, like the ones disclosed in U.S. Pat. Nos. 5,290,584 and 5,731,029, use meat and starch as raw materials. On the other hand, U.S. Pat. No. 4,537,788 describes a product made with eggs, flavoring and vegetable protein, where the mix of the ingredients is dried by heating. The disadvantage of these products is that they require preservatives.

Beside the products described above, there are some sweets and appetizers that use the cactus family as raw materials. For example, International Patent Application Serial Number PCT/MXOI/00085 refers to a sweet made with dehydrated prickly pear cactus (Opuntia ssp.) processed with sugar. Other example is U.S. Pat. No. 3,057,736 that refers to a hamtype product where the fibers of a cactus of the Cereeae variety, such as the ferocactus and the echinocactus, act as stabilizers.

Speaking of cactus plants, it is well known that the prickly pear cactus possesses very important nutritional and medicinal properties. This plant is rich in soluble fibers of slow absorption that help to keep stable the blood sugar contains insoluble fibers that prevent constipation and colon cancer. It has been demonstrated that the pectin in the prickly pear pad pulp helps to reduce the cholesterol levels. The prickly pear pad contains carbohydrates and is rich in calcium.

Until now a vegetarian alternative to appetizers made with cured meat or its imitations, having the properties of the prickly pear pad, did not exist. Therefore, the present invention proposes the use of seasoned and dehydrated prickly pear pads to make a product similar to the cured-meat appetizers, but with superior nutritional and medicinal properties. Besides, the product disclosed herein does not require preservatives, is free of fat, hormones, and animal toxins, and is cholesterol free. Other advantage of the product of the present invention is that the raw material is economically affordable.

### BRIEF SUMMARY

To provide a vegetarian alternative to appetizers made from cured meat or its imitations, but with an improved flavor and texture.

To provide food product similar to a cured-meat appetizer, and cholesterol-free.

To provide a food product similar to a cured-meat appetizer, rich calcium and other nutrients.

To provide a food product similar to a cured-meat appetizer, free of fat and animal hormones.

To provide a food product similar to a cured-meat appetizer, free of preservatives, that does not require refrigeration and with a long shelf life.

To provide a food product similar to a cured-meat appetizer, with a high content of soluble and insoluble fibers that prevent constipation, reduce cholesterol levels and help to regulate blood sugar levels.

To provide an economically affordable food product similar to a cured-meat appetizer.

### DETAILED DESCRIPTION OF THE INVENTION

The product of the present invention, in its preferred embodiment, is made with the young pads of the prickly pear cactus; the selected pads should be very flexible and have a smooth texture so that after being seasoned they form small creases in the surface. The preferred size of the pads before processing ranges between 17 and 27 centimeters long because, if they are smaller, the final product would be very thin, and if they are larger, the skin is not very soft and is harder to chew.

The washed and/or disinfected prickly pear pads, being edge trimmed and free of prickles, are cut in strips or slices. Ideally, the pads are cut in slices to obtain a shape that closely resembles that of cured meat. In the preferred embodiment, the thickness of each slice before cooking and seasoning ranges between 0.3 and 1 centimeter.

The prickly pear pad strips or slices are boiled in water at a ratio of 1 to approximately 3 parts of boiling water per 1 part of prickly pear pads, for 20 to 30 minutes, constantly stiffing, and then draining the prickly pear strips. The cooking phase can be carried out with a pressure cooker or autoclave, thereby reducing the cooking time by ½ to ¾.

In its preferred embodiment, the cooked and drained prickly pear strips or slices are seasoned, ideally using from 1 to 3 parts of seasoning per 1 part of cooked prickly pear strips, for 10 to 50 minutes, constantly stirring the mixture. This step can also be carried out with a pressure cooker or autoclave, reducing the cooking time by ½ to ¾. The strips or slices can also be seasoned by simply cooling the cooked prickly pear strips with purified water and then submerging them in the seasoning mix at room temperature for 30 minutes to 5 hours.

Subsequently, the prickly pear strips or slices are drained and dehydrated, preferably putting them in trays and circulating air to a temperature ranging from 110 0 F (433° C.) ° C.) for 2 to 20 hours.

The dried product is left to cool to stabilize its humidity until it is less than 40% by weight, ideally less than 35% by weight, e.g., between 20 and 35% by weight.

The amount of prickly pear pads (on a dry basis) in the product ranges approximately from 45% to 70% by weight, preferably from 55% to 65% by weight. The amount of seasoning (on a dry basis) used in the product ranges from 5% to 25% by weight, preferably from 10% to 20% by weight.

The resulting product is flexible, deformable, and chewable, and its thickness ranges from 0.5 to 3 millimeters. It does not require other adjuvants to achieve the consistency, texture, and flavor of cured meat.

The pH of the product varies between 3 and 4, depending of the seasoning used. Because of this pH values and the low water contents of the product, bacteria growth is prevented and therefore the product does not require preservatives or refrigeration. The shelf life of the product is of at least one year.

To keep the resulting product in hygienic conditions and to preserve its properties, it should be packaged in a sealed plastic packaging.

The ingredients used to season the cooked prickly pear pads are those generally used in the manufacturing of cured-meat appetizers, such as salt, garlic, pepper, etc. One or more seasonings can be used, such as chili and or bits; ginger or other processed seasonings such as soy sauce, Worcestershire sauce and teriyaki sauce. Other ingredients that can be added are sweeteners, vinegar, wine, lemon, tomato, citric acid, malic acid, tartaric acid, etc. The product can even be smoked. Proteins and vitamins can also be added.

The color of the final product is, in most cases, almost black. Depending on the seasoning employed, it can range from dark tones of green or brown to almost black.

It is understood that the compositions disclosed in the present invention are not limited to the use of specific species of prickly pear cactus, specific flavoring or seasoning, but include several types and/or combinations of these materials.

The approximate nutritional contents of foodstuff of the present invention is shown in Table 1.

TABLE 1

| Component | % by weight |
|---|---|
| Soluble and insoluble fiber | From 1% to 20% |
| Humidity | less than 40%; |
| | preferably less than 35% |
| Fat | From 0 to 2% |
| Carbohydrates | From 15 to 50% |
| Proteins | From 10 to 20% |
| Ashes | From 10 to 25% |
| Calcium | From 0.1 to 1% |

### EXAMPLE 1

The cooked and drained slices or strips of prickly pear pads are seasoned employing the formula shown in Table 2.

TABLE 2

| Ingredient | Percentage by weight |
|---|---|
| Cooked prickly pear pads | 50% |
| Dried chili peppers in | 15% |
| powder form | |
| Teriyaki sauce | 30% |
| Garlic and onion in | 5% |
| powder form | |

The resulting product of seasoning, draining, and dehydrating the prickly pear pads has a dark green color, shows small creases in the surface and has a soft consistency. The product is pliable and chewable and has approximately the following composition (see Table 3).

TABLE 3

| Ingredient | Percentage by weight |
|---|---|
| Cooked prickly pear pads | 49.5% |
| Chili | 5.5% |
| Teriyaki sauce | 11.0% |
| Garlic and Onion | 2.0% |
| Humidity | 32.0% |

The pH of the product is approximately equal to 3.6. The components of the final product were also e approximate values of which are shown in Table 4.

TABLE 4

| Component | % by weight |
|---|---|
| Fiber | 1% |
| Humidity | 32% |
| Fat | 1% |
| Protein | 19% |
| Carbohydrates | 22% |
| Ashes | 25% |
| Calcium | 0.25% |

### EXAMPLE 2

The cooked prickly pear slices or strips are cooled in purified water and submerged in a seasoning liquid mixture according to Table 5.

TABLE 5

| Ingredient | Percentage by weight |
|---|---|
| Cooked prickly pear pads | 50.0% |
| Dried pepper in bits | 2.0% |
| Teriyaki sauce | 43.0% |
| Garlic and onion in | 2.0% |
| powder form | |
| Ginger | 2.9% |
| Citric acid | 0.1% |

The resulting product, after draining and dehydrating the prickly pear strips has a dark green color, a texture showing small creases in the surface and has a soft consistency. The product is pliable and chewable.

The resulting product has approximately the composition shown in Table 6.

TABLE 6

| Ingredient | Percentage by weight |
|---|---|
| Cooked prickly pear pads | 65.5% |
| Chili | 0.4% |
| Teriyaki sauce | 8.0% |
| I Garlic and Onion | 0.4% |
| I Ginger | 0.6% |
| Citric acid | 0.1% |
| Humidity | 25.0% |

Acidity tests of the product were carried out. The pH is approximately equal to 3.5. The nutritional contents of the product were determined, and the (approximate) values obtained are shown in Table 7.

TABLE 7

| Ingredient | % by weight |
|---|---|
| Fiber | 5% |
| Humidity | 25% |
| Fat | 0% |
| Protein | 13% |
| Carbohydrates | 47% |
| Ashes | 10% |
| Calcium | 0.10% |

In the preferred embodiment of the present invention the prickly pear pad is sliced, although it can be cut in strips and seasoned to achieve a similar product to the one described above.

Since the product of the present invention is made of a vegetable, it is free of fat, toxins, and animal hormones. Besides, the product of the present invention allows the user to benefit from the many beneficial qualities of prickly pear, like being rich in dietetic soluble and insoluble fibers that prevent constipation and colon cancer, and help to reduce cholesterol levels and help to regulate blood sugar levels. Other advantage of the product of the present invention is that the raw material is economically affordable, so the resulting product is very cheap.

Even if the invention has been shown and described according to a preferred embodiment, those skilled in the art will understand that many changes can be carried out in the same, and that equivalent elements can be substituted for those hereby indicated, which will be covered by the spirit and scope of the invention, as it is outlined in the following claims.

What is claimed is:

1. A food product made from strips or slices of cooked, seasoned and dehydrated prickly pear pads; the product being characterized by resembling cured meat; the prickly pear pads make up 45% to 70% by weight of the product; seasoning make up 5% to 25% by weight of the product, and the weight percentage of humidity is less than 40% and the pH value is between 3 and 4.

2. The food product according to claim 1, characterized in that the humidity weight percentage is equal to or less than 35%.

3. The food product according to claim 1, characterized in that it has a soft consistency, is flexible, pliable and chewable.

4. The food product according to claim 1, characterized in that its color varies from tones of dark green or brown to black.

5. The food product according to claim 1, characterized by a thickness between 0.5 and 3 millimeters.

6. The food product according to claim 1, characterized by a humidity weight percentage ranging from 25 to 30%, a weight percentage of prickly pear pad ranging from 55 to 65%, and a weight percentage of seasoning ranging from 10 to 20%.

7. The food product according to claim 1, characterized by being packaged in a sealed plastic package.

8. The food product according to claim 1, wherein the seasoning ingredients of the food product are chosen among one or more of salt, garlic, pepper, chili, onion, ginger, soy sauce, Worcestershire sauce, teriyaki sauce, sweeteners, vinegar, wine, lemon, tomato, citric acid, malic acid and tartaric acid.

9. The food product according to claim 4, wherein the color of the product is dark green.

10. The food product according to claim 1, wherein the product shows small creases in the surface.

11. The food product according to claim 2, characterized by having, by weight of the product, a percentage of fiber ranging from 1% to 20%; a weight percentage of fat from 0 to 2%; a weight percentage of carbohydrates from 15 to 50%; a weight percentage of 20 proteins from 10 to 20%, a weight percentage of ashes from 10 to 25%; and a weight percentage of calcium from 0.1 to 1%.

12. The food product according to claim 1, having by weight of product, a percentage of cooked prickly pear a percentage of chili of 5.5%, a percentage of teriyaki sauce of 11%, a percentage of garlic and onion of 2%, a percentage of humidity of 32%.

13. The food product according to claim 13, having a weight percentage of fiber of 1%; a weight percentage of humidity of 32%, a weight percentage of fat of 1%, a weight percentage of protein of 19%, a weight percentage of carbohydrates of 22%, a weight percentage of ashes of 25% and a weight percentage of calcium of 0.25%.

14. The food product according to claim 14, wherein the pH of the product is equal to 3.6.

15. The food product according to claim 1, characterized by a weight percentage of cooked prickly pear of 65.5%, a weight percentage of chili of 0.4%, a weight percentage of teriyaki sauce of 8%, a weight percentage of garlic and onion of 0.4%, a weight percentage of ginger of 0.6%, a weight percentage of citric acid of 0.1% and a weight percentage of humidity of 25%.

16. The food product according to claim 16, characterized by having a weight percentage of fiber of 5%, a weight percentage of humidity of 25%, a weight percentage of protein of 13%, a weight percentage of carbohydrates of 47%, a weight percentage of ashes of 10% and a weight percentage of calcium of 0.1%.

17. The food product according to claim 17, wherein the pH of the product is equal to 3.5.

18. The food product according to claim 1 characterized by being a smoked product.
